(19) United States
(12) Patent Application Publication
(10) Pub. No.: US 2025/0296532 A1
(43) Pub. Date: Sep. 25, 2025

(54) Tire Barrier Device

(71) Applicant: Micetight, Inc., Mukwonago, WI (US)

(72) Inventor: Daniel Thomas Hanson, Mukwonago, WI (US)

(21) Appl. No.: 19/081,153

(22) Filed: Mar. 17, 2025

Related U.S. Application Data
(60) Provisional application No. 63/568,477, filed on Mar. 22, 2024.

(51) Int. Cl. B60R 99/00; A01M 29/30

(52) U.S. Cl. CPC B60R 99/00; A01M 29/30; B60R 2099/005

(57) ABSTRACT

Systems and methods for surrounding a tire with a device that prevents pests such as mice or other rodents from climbing the tire to enter an interior of the vehicle are provided. The device includes various components such as walls that are releasably secured to one another to surround the tire to prevent mice and other rodents from climbing up the tire. The first component includes a base wall and first and second sides that are rotatable relative to the base wall. Additionally, the second component includes a single wall with channels at opposing ends that can releasably hold the first and second sides of the first component. The second component is substantially flat, whereas the first component is movable between an extended position where the sides are substantially perpendicular to the base wall, and a collapsed position where the sides are substantially parallel and flat against the base wall.

### CROSS-REFERENCE(S) TO RELATED APPLICATION(S)

This present application claims priority on U.S. Provisional Patent Application Ser. No. 63/568,477, filed on Mar. 22, 2024 and entitled Tire Barrier Device, the entire contents of which are hereby expressly incorporated by reference into the present application.

### BACKGROUND OF THE INVENTION

### 1. Field of the Invention

The present invention relates in general to the field of pest and rodent control and prevention. More particularly, the present invention relates to a barrier system that is used to prevent pests or rodents, such as mice or rats, from entering a vehicle or other area. Specifically, a preferred embodiment of the present invention relates to a barrier that surrounds a tire and prevents or otherwise makes it difficult for a mouse or other rodent or pest to climb up the tire to enter the vehicle.

### 2. Discussion of the Related Art

A common issue with a variety of vehicles, including recreational vehicles (RVs), trailers, cars, campers, boats, and the like occurs when mice or other rodents or pests enter the interior of the vehicle. Particularly when the vehicle is stored for an extended period of time, mice oftentimes will enter the interior of the vehicle and create homes in the cushions, seats, and the like. This can be very damaging because of chewing, nests, mouse waste, bad smells, etc. which can sometimes be so destructive that an entire vehicle can be deemed totaled by an insurance company. These issues are oftentimes exacerbated in cold climates when pests have limited options in terms of warm locations to live. In other instances, the mice will remove certain materials, such as stuffing, and take those materials to a different location. The majority of the time, the only portion of the vehicle that has contact with the ground or other surfaces is the tires. Thus, mice and other pests typically will only be able to access the interior of the vehicle by first climbing up the tires.

One way to prevent rodents from entering a vehicle is to place mouse or other rodent traps around the perimeter of the vehicle. While this does have the effect of catching and/or killing some rodents located around the perimeter of the vehicle, it is still possible that the rodents avoid the mouse traps and enter the vehicle anyway. Similarly, it is unappealing to have mouse traps located all over the place, especially for users having small children, pets, and the like. Other attempted solutions include use of various sprays, soaps, dryer sheets, and other materials having odors, textures, and the like that mice and rodents are repelled by. Further still, some noise machines are used to detour the mice.

Additionally, certain barriers have been introduced that surround the entirety of a vehicle. These systems are very large, heavy, and difficult to construct. Such systems are difficult, if not impossible, to move from place to place quickly and easily. Additionally, users may elect not to move large and heave barriers, in which case a user to very carefully maneuver a vehicle within a pre-constructed or permanent barrier.

What is therefore needed is a device that prevents mice and other rodents from entering the interior of a vehicle. What is further needed is a device that prevents mice and other rodents from climbing up tires into the interior of a vehicle. What is further needed is a device that surrounds one or more tires in order to prevent or otherwise inhibit pests from climbing up the side of a tire into an interior of the vehicle. This helps reduce costs to owners of the vehicle, as well as insurance companies who may be responsible for costs associated with repair or replacement of damaged vehicles.

### SUMMARY AND OBJECTS OF THE INVENTION

By way of summary, the present invention is directed to a device configured to prevent mice or other rodents or pests from entering a vehicle as described herein, as well as an associated method. According to an aspect of the present invention, the device includes a first component and a second component that is configured to releasably attach to the first component. When the components are releasably attached to one another, the components surround one of the tires. The device includes a first end wall, a second end wall, a first side wall, a second side wall, and at least one securement configured to receive an edge of at least one of the walls, such as a u-channel member. When the securement device receives the edge, the walls surround the tire.

According to another aspect, the u-channel member includes a first tab, a second tab, and a first channel formed between the first tab and the second tab. The first channel is configured to receive a first edge. The device may include first and second u-channel members, where the second u-channel member also has a third tab, a second tab, and a second channel therebetween. The second channel is configured to receive a second edge. Additionally, the first end wall may further include a first edge and the second end wall may include a second edge. The first edge is releasably insertable into the first channel, and the second edge is releasably insertable into the second channel. For instance, the edges may be held within the channels using magnets.

According to yet another aspect, the first component includes the first side wall, the first end wall, and the second end wall, where the second component includes the second side wall. The first side wall is pivotably connected to a first end of the second end wall, and the second side wall is pivotally connected to a second end of the second end wall. As such, the first side wall and the second side wall are pivotable between a first position and a second position. In the first position, the first end wall and the second end wall extend substantially parallel along the first side wall. In the second position, the first end wall and second end wall extend substantially perpendicular to the first side wall. In the second position, a first edge of the first end wall and a second edge of the second end wall is releasably received into the channels.

According to another aspect, the device also includes a cutout that extends through one of the walls, as well as plurality of sliding panels configured to move upwardly and downwardly relative to the cutout. The plurality of sliding panels is movable between a first position where the plurality of sliding panels is located beneath the cutout, and a second position where the plurality of sliding panels is located above the cutout. In the second position, the plurality of sliding panels may abut an axle of the vehicle.

According to another aspect, a method of using the device is provided. The method includes the steps of releasably securing a first component to a second component around the tire of a vehicle, releasing the first component from the second component, and collapsing at least one of the first component and the second component into a substantially flat orientation. Additionally, the method may include the steps of moving the first component to an extended position where the first side wall and the second side wall are substantially perpendicular to a base wall, and moving the first component to a collapsed position in which the first side wall and the second side wall are substantially parallel to the base wall. Additionally, the method may include the steps of inserting a first end of the first side wall into a first channel associated in the second component, and inserting a second end of the second side wall into a second channel associated with the second component. The method may also includes the steps of moving a plurality of sliding panels to a first position where the panels are located beneath a cutout formed in a wall of the device and moving the panels to a second position where the panels are at least partially covering the cutout, and where at least some of the panels abut a component of the vehicle, such as the axle.

These, and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 illustrates a perspective view of an inventive barrier device used to prevent entry of mice or other rodents into a vehicle;

FIG. 2 illustrates a perspective view of the inventive barrier device;

FIG. 3 illustrates a top plan view of the inventive barrier device;

FIG. 4 illustrates a front elevation view of the inventive barrier device in a first position;

FIG. 5 illustrates a front elevation view of the inventive barrier device in a second position;

FIG. 6 illustrates an exploded perspective view of the inventive barrier device;

FIG. 7 illustrates a perspective view of the inventive barrier device with arrows showing the separation of the components and collapsing a first component;

FIG. 8 illustrates a perspective view of the inventive barrier device with the components in a collapsed configuration;

FIG. 9 illustrates a perspective view of the inventive barrier device installed relative to a vehicle with the plurality of sliding panels abutting the vehicle.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word connected, attached, or terms similar thereto are often used. They are not limited to direct connection but include connection through other elements where such connection is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description.

### 1. System Overview

A device is provided that keeps mice or other pests from climbing up a user's tires to enter any vehicle, such as recreational vehicles, campers, boats, enclosed trailers, open trailers, trucks, cars, etc. This is done using two or more components. The first component is made up of three sides connected by hinges for quick set-up and fold-away storage. The second component is one fixed piece with an adjustable back panel for various axle heights. The second component connects to the first component with the use of magnets.

Additionally, because vehicles are routinely moved from location to location, it is important that the device is quickly and easily movable with the vehicle.

### 2. Detailed Description of Preferred Embodiments

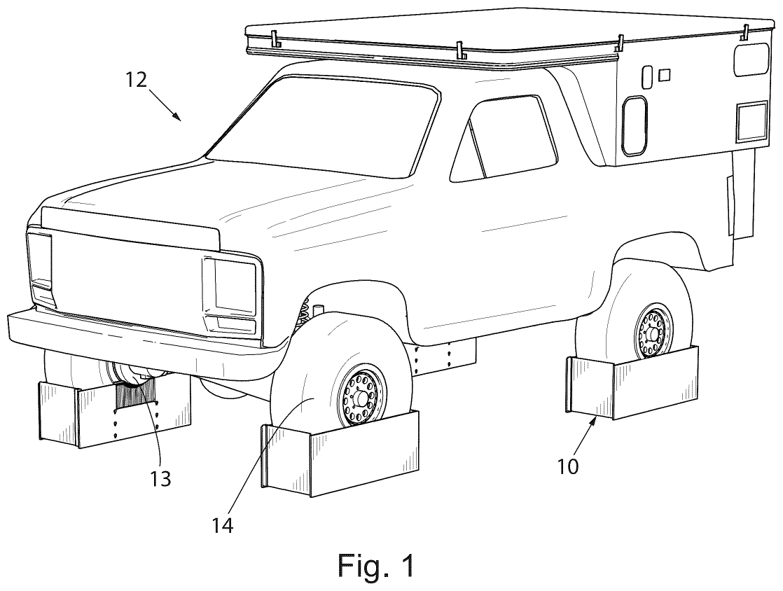

The present invention is directed to a device 10 configured to prevent mice, rodents, and other pests from entering a vehicle 12 by climbing up the tires 14 of the vehicle 12. More specifically, the device 10 is configured to surround the tire 14, such that it makes it difficult or impossible for a rodent to climb up the side of the tire 14 in order to enter the vehicle 12. FIG. 1 shows a vehicle 12 with the device 10 surrounding the tires 14. While some of the figures show a non-limiting example of the device 10, the device 10 and any associated components could be of any dimensions, sizes, shapes, etc. The illustrated device 10 is dimensioned to surround standard tire 14 dimensions. For instance, the device may be approximately 10-20 inches, more preferably between approximately 12-18 inches, and even more preferably approximately 14 inches in width; approximately 30-40 inches, more preferably between approximately 32-38 inches, and even more preferably approximately 35 inches in length; and approximately 8-20 inches, more preferable between approximately 10-16 inches, and even more preferably approximately 13 inches in height.

Additionally, the device 10 should be durable but portable. As such, the device 10 may be between approximately 10-30 pounds, more preferably between 15-25 pounds, and even more preferably approximately 20 pounds. The device 10 may be made of any durable, weatherproof, or weather-resistance material, including by not limited to metal, such as stainless steel, plastic, and the like.

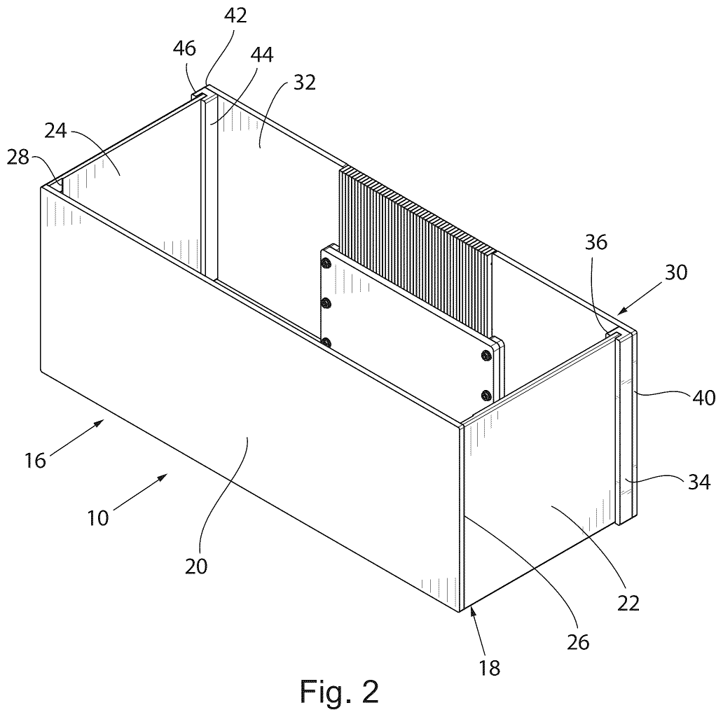

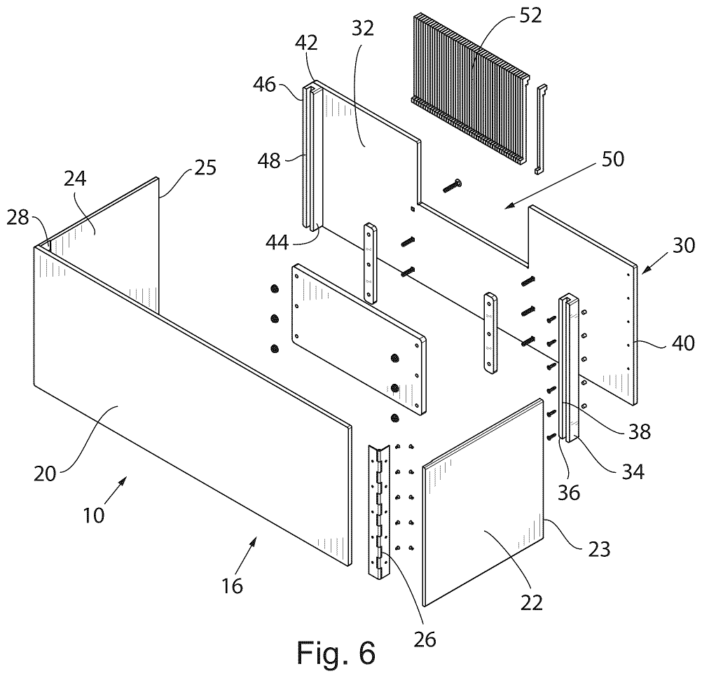

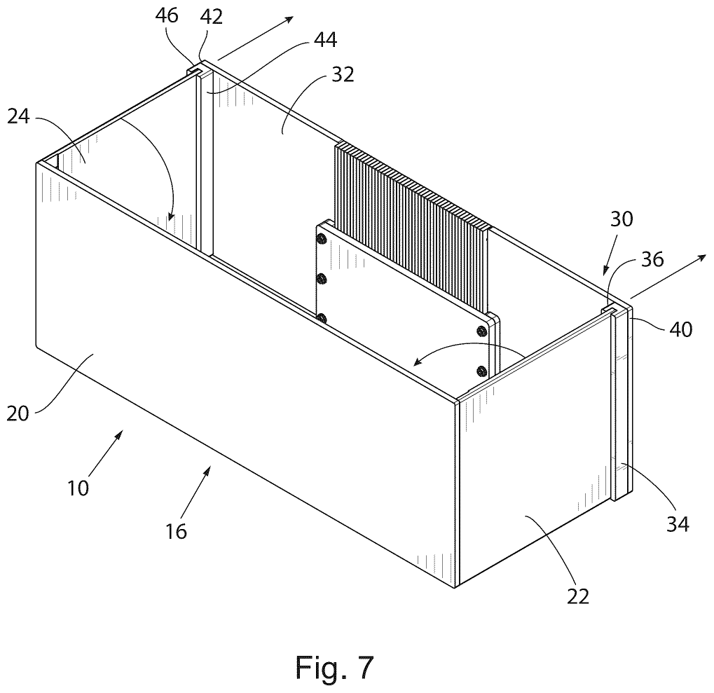

Turning now to FIGS. 2-8, one potential embodiment of the device 10 is shown. As illustrated, the device 10 includes two primary components. The first component 16 includes a multi-sided body 18 that can be quickly and easily moved between multiple positions. For instance, as shown, the multi-sided body 18 includes a base/side wall 20, as well as first and second end walls 22, 24. It should be noted that various walls are described herein, including base, side, and end walls. The use of base, side, and end are for explanatory purposes only, and should not be deemed to be limited, as each wall could be move or oriented in different ways. In the illustrated embodiment, the first end wall 22 is rotatable or otherwise movable about the base wall 20 about a first hinge 26. This is best shown in FIG. 7. Similarly, the second end wall 24 is rotatable or otherwise movable about the base component 20 about a second hinge 28. The first and second walls 22, 24 each have a far edge 23, 25 opposite the hinges. In the illustrated embodiment, the hinges 26, 28 are piano hinges, although other hinges could be used. Alternatively, hinges need not be used, in which case the end walls 22, 24 are pivotable, rotatable, or otherwise movable about the side wall 20.

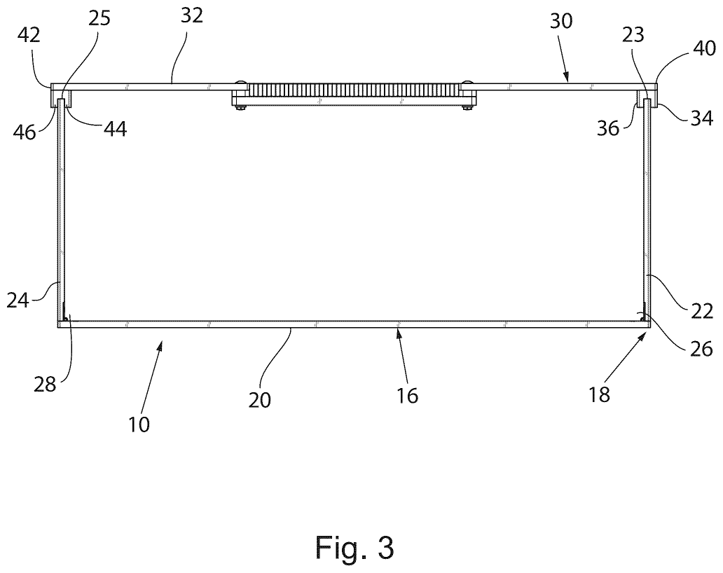

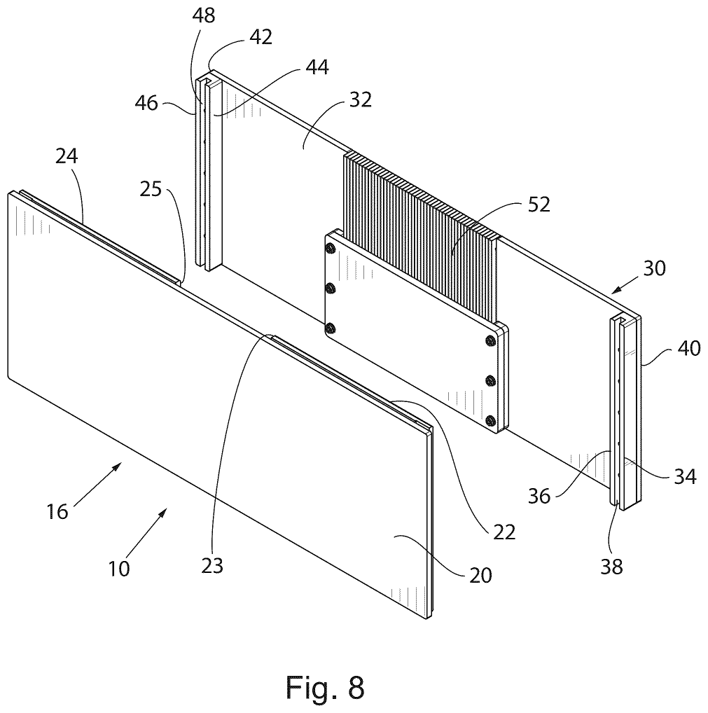

This allows the device 10 to quickly and easily be moved between a storage position in which the end walls 22, 24 rest against, fold, or otherwise extend parallel with and flat against the side wall 20 to a use position in which the end walls 22, 24 are pivoted or otherwise moved from the side wall 20 about the hinges 26, 28 so that the end walls 22, 24 are substantially perpendicular to the side wall 20. FIGS. 2 and 3 shows the first component 16 in the use position where the first component 16 is configured to surround a tire 14. Because of the ease with which the first component 16 can be moved between the storage and use positions, the device 10 can quickly and easily be transported and then installed relative to a tire 14, after which it can again be moved into the storage position and moved to a new location. The storage position is shown in FIG. 8.

The second component 30 will be described with reference to FIGS. 2-8. As shown in the figures, the second component 30 includes a single wall 32 along with various components configured to secure the first component 16 to the second component 30. The second component also includes a securement device in the form of a first u-channel member 60 that includes first and second tabs 34, 36 extending therefrom, with a first channel 38 formed between the tabs 34, 36 at a first end 40 of the single wall 32. On the second end 42 of the single wall, a similar a second u-channel member 62 is provided with third and fourth tabs 44, 46 with a second channel 48 formed therebetween. The u-channel members, tabs, and channels serve as securement devices that receive components from the first component 16 in order to releasably secure the first component 16 and the second component 30 together. As shown, the channels 38, 48 extend substantially perpendicular to the single wall 32. The channels 38, 48 are configured to have a width that accommodates the width of the respective edges 23, 25 of the first and second end walls 22, 24. More specifically, the edges 23, 25 of the first and second end walls 22, 24 can be inserted into the channels 38, 48, such that the first and second end walls 22, 24 are secured within the channels 38, 48 between the tabs 34, 36, 44, 46. The first and second end walls 22, 24 may be releasably secured within the channels 38, 48 by any suitable fastener or securement device, as shown by magnets. Similarly, the walls 22, 24 may be releasably secured within the channels 38, 48 using a pressure fit, clips, hooks, buttons, hook-and-loop fasteners, and the like. Thus, when the end walls 22, 24 are properly located in the channels 38, 48, the first component 16 and the second component 30 will remain engaged with one another until a user disengages them. Thus, when the first component 16 and the second component 30 are engaged with one another, a four-sided device 10 is created that is configured to surround the tire 14.

In other embodiments, the first and second components 16, 30 may each have two sides, such that a similar four-sided device is created. Alternatively still, each the device 10 may not have first and second components 16, 30, and instead have a single component that is manufactured together. For instance, the single component may include four sides that all may be collapsed relative to one another such that a user need not worry about first and second components.

Additionally, the device 10 may include other features to help ensure a secure fit relative to the vehicle 12. More specifically, these features enable the device 10 to tightly fit relative to the vehicle 12 and its associated parts so as to prevent the formation of openings that a mouse, rodent, or other pest may enter to climb into the vehicle 12.

For instance, a cutout/opening 50 may be formed in one of the walls, with other components movable relative to the cutout/opening 50 to prevent the formation of openings that a rodent may try to climb through. For instance, as shown, the cutout 50 is formed in the single wall 32 of the second component 30. In the illustrated embodiment, the cutout 50 may be approximately 8-16 inches, more preferably be approximately 10-14 inches, and even more preferably be approximately 12 inches in width; and approximately 3-8 inches, more preferably approximately 4-7 inches, and even more preferably approximately 6 inches in height.

A plurality of sliding panels 52 or the like are located adjacent to the cutout 50. As shown, each of the plurality of sliding panels 52 have a narrow width, and are in direct contact with adjacent panels 52. As shown, each of the sliding panels 52 is approximately 0.1-0.4 inches, more approximately preferably 0.2-0.3 inches, and even more preferably approximately 0.25 inches in width, and the height should exceed the height of the cutout 50 so that the sliding panels 52 remain engaged with the device 10. Beneath the cutout 50 is a back panel 54 mounted to the single wall 32. The space between the single wall 32 and the back panel 54 is configured to enable slidable movement of the plurality of sliding panels upwardly and downwardly relative to the device 10.

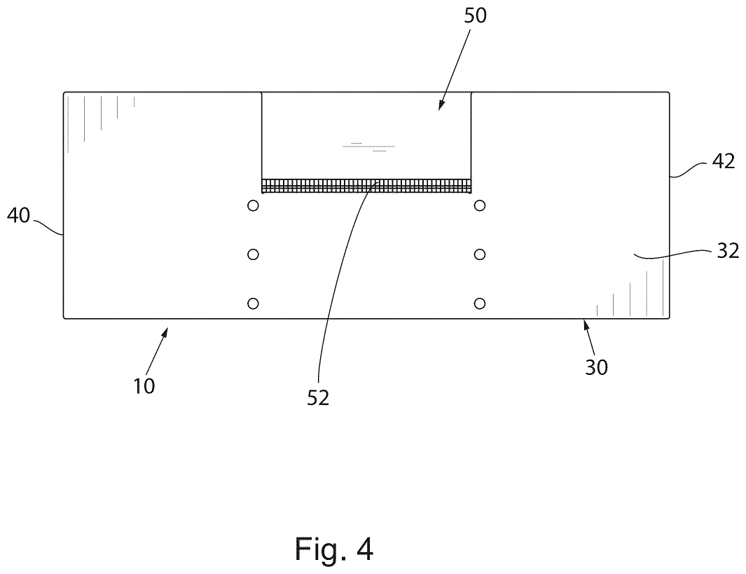

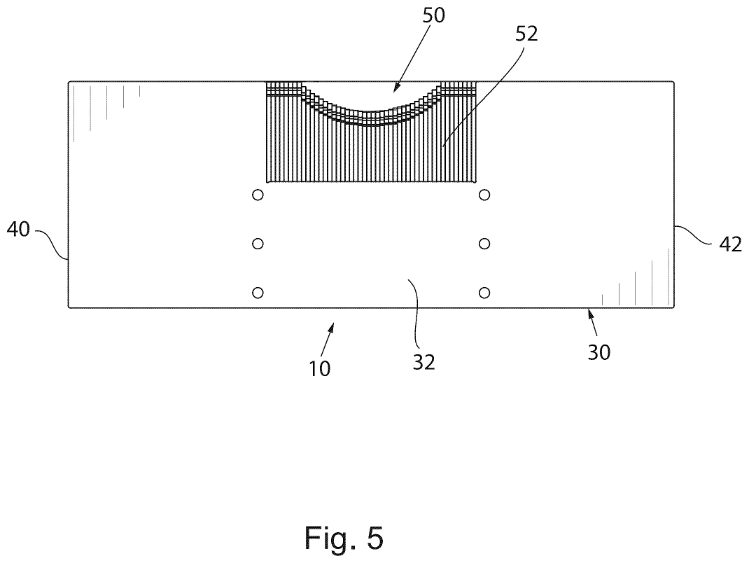

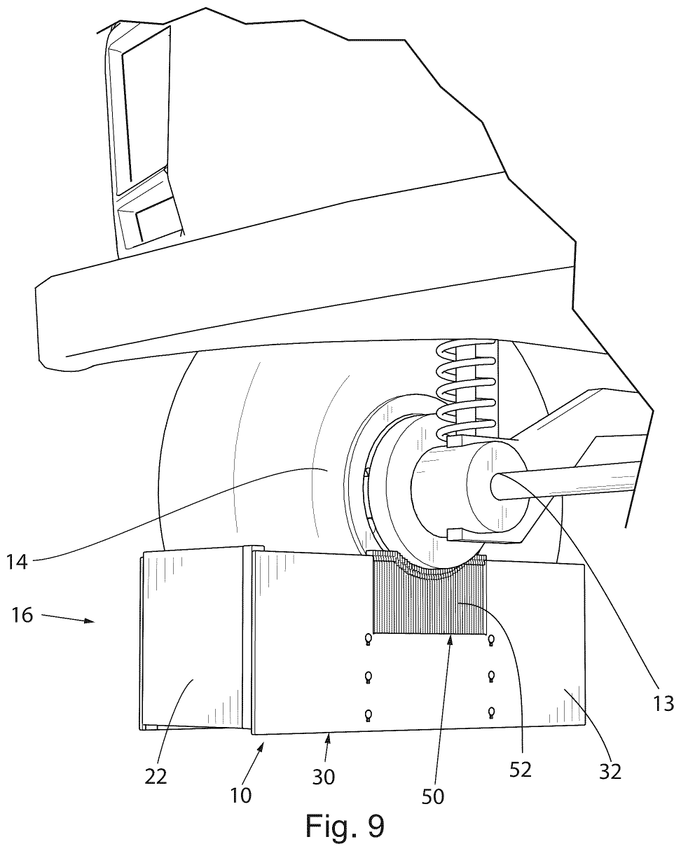

There are a sufficient number of panels 52 in the lateral direction to cover the cutout 50. Additionally, the panels 52 are located between the single wall 32 and the back panel 54 such that there is contact pressure between each adjacent panel 52. This enables the panels 52 to remain in place after being repositioned by a user, either in the upward or downward direction. Having too many panels would make it difficult or impossible to move the panels, and having too few panels would make all of the panels slide to the downward position. As such, a user has control over whether the full cutout 50 remains exposed (see FIG. 4), the full cutout 50 is covered by the plurality of sliding panels 52 (see FIGS. 2, 7, and 8), or the cutout 50 is partially covered by the sliding panels 52 (see FIGS. 5 and 9). For instance, in one embodiment, a user may manipulate the plurality of sliding panels 52 in such a way as to surround an axle 13 of the vehicle 12 as shown in FIG. 9. In moving the plurality of sliding panels 52 to a position directly proximate to the axle 13, there is very little gap between the device 10 and the axle 13 and associated tire 14. This makes it very difficult for a pest to enter the vehicle 12.

Advantageously, the inclusion of the sliding panels 52 and cutout 50 allows the device 10 to be successfully used with any number of different vehicles 12 having different tire heights, axle dimensions, and other configurations. As such, users can purchase a single set of devices 10 and continue to use those devices even if the user purchases a new vehicle. Similarly, a user can move the devices 10 to different vehicles owned by the user, otherwise, the user can allow the devices 10 to be used with other vehicles. As such, the device 10 is virtually universally usable regardless of the vehicle 12 type.

Each of the components 16, 30, and any other components of the device 10 described herein, are configured to have a flat outer surface that make it difficult, if not impossible, for a mouse or other rodent to climb up the device 10. In addition to the flat surface, the material used to manufacture the components may be inherently slippery or slip to again make it more difficult, if not impossible, for a mouse or other rodent to climb up the device 10. As shown, the components 16, 30 extend substantially vertically from a ground surface, although they could similarly be sloped slightly outwardly away from the tire 14, which would make it even more difficult for a rodent to climb up the surface. As such, the mice or other rodents will be prevented from climbing up the tires 14.

Additionally, a method of using the device 10 will be described. Various steps will be described, but it should be noted that the steps may occur any order, additional steps not described herein may also occur, and each of the below steps need not be performed. The method initially provides that a first component is releasably secured to a second component around a tire of a vehicle. Once the first component is released from the second component, at least one or both of the first and second components are collapsed into a substantially flat orientation. This allows the components to easily be stacked or otherwise arranged relative to one another for storage, transportation, and the like. In order to collapse the component, one of the components may initially be in an extended position in which first and second sides are oriented perpendicular to a base wall. The component may then be moved to a collapsed position in which the first and second sides are oriented substantially parallel to the base wall. When releasably securing the components together, a first end of the first side and a first end of the second side are inserted into first and second channels associated with the second component. Additionally, a plurality of sliding panels may be slid upwardly or downwardly relative to the device in order to enable the panels to be located directly proximate to components of the vehicle to prevent the formation of openings that a pest may enter. For instance, the sliding panels may be moved to be flush with the tire and/or axle of the vehicle.

All the disclosed embodiments are useful in conjunction with prevention of rodent and other pest entry into the interior of a vehicle. There are virtually innumerable uses for the present invention, all of which need not be detailed here. All the disclosed embodiments can be practiced without undue experimentation.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

In addition, the individual components need not be fabricated from the disclosed materials, but could be fabricated from virtually any suitable materials. Moreover, the individual components need not be formed in the disclosed shapes, or assembled in the disclosed configuration, but could be provided in virtually any shape, and assembled in virtually any configuration. Further, although the various components are described herein as being physically separate modules, it will be manifest that any of the components may be manufactured together or later assembled with one another. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

What is claimed is:

1. A device for prevention of entry by a rodent into a vehicle having a plurality of tires comprising:
a first component; and
a second component configured to releasably attach to the first component;
wherein the first component and the second component surrounds a tire of the vehicle when the second component is releasably attached to the first component.

2. The device of claim 1, further comprising:
a first end wall;
a second end wall;
a first side wall;
a second side wall; and
at least one securement device configured to receive an edge of at least one of the walls;
wherein the first end wall, the second end wall, the first side wall, and the second side wall surround the tire of the vehicle when the at least one securement device receives the edge.

3. The device of claim 2, wherein the at least one securement device comprises a first tab, a second tab, and a channel formed between the first tab and the second tab, the channel configured to receive the edge.

4. The device of claim 3, wherein the at least one securement device further comprises:
a first securement device comprising a first tab, a second tab, and a first channel therebetween configured to receive a first edge; and
a second securement device comprising a third tab, a fourth tab, and a second channel therebetween configured to receive a second edge.

5. The device of claim 4, wherein the first end wall further comprises the first edge;
wherein the second end wall further comprises the second edge;
wherein the first edge is releasably insertable into the first channel; and
wherein the second edge is releasably insertable into the second channel.

6. The device of claim 5, first side wall first edge is releasably held within the first channel by a magnet; and
wherein the second side of the second side wall second edge is releasably held within the second channel by a magnet.

7. The device of claim 2, wherein the first component comprises the first side wall, the first end wall, and the second end wall;
wherein the second component comprises the second side wall;
wherein the first side wall is pivotably connected to a first end of the second end wall; and
wherein the second side wall is pivotally connected to a second end of the second wall.

8. The device of claim 7, wherein the first side wall and the second side wall are pivotable between:
a first position where the first end wall and the second end wall extend substantially parallel along the first side wall; and
a second position where the first end wall and the second end wall extend substantially perpendicular along the first side wall.

9. The device of claim 8, wherein when the first side wall and the second side wall are in the second position, a first edge of the first side wall is releasably received into the first channel and a second edge of the second side wall is releasably received into the second channel.

10. The device of claim 2, further comprising:
a cutout extending through the first end wall; and
a plurality of sliding panels configured to move upwardly and downwardly relative to the cutout.

11. The device of claim 10, wherein the plurality of sliding panels is movable between:
a first position where the plurality of sliding panels is located beneath the cutout; and
a second position where the plurality of sliding panels is located above the cutout.

12. The device of claim 11, wherein the plurality of sliding panels abut an axle of the vehicle in the second position.

13. A method of using a device for prevention of entry by a rodent into a vehicle having a wheel and an axle comprising the steps of:
releasably securing a first component to a second component around the tire of the vehicle;
releasing the first component from the second component; and
collapsing at least one of the first component and second component into a substantially flat orientation.

14. The method of claim 13, further comprising the steps of:
moving the first component to an extended position in which a first side wall and a second side wall are substantially perpendicular to a base wall; and
moving the first component to a collapsed position in which the first side wall and the second side wall are substantially parallel to the base wall.

15. The method of claim 14, further comprising the steps of:
inserting a first end of the first side wall into a first channel associated with the second component; and
inserting a second end of the second side wall into a second channel associated with the second component.

16. The method of claim 13, further comprising the steps of:
moving a plurality of sliding panels to a first position where the plurality of sliding panels is located beneath a cutout formed in a wall of the first component or the second component; and
moving the plurality of sliding panels to a second position where the plurality of sliding panels are at least partially cover the cutout, and where at least some of the plurality of sliding panels abut a component of the vehicle.

17. A device configured to surround a tire comprising:
a first component comprising:
a first side wall;
a first end wall rotatably mounted to the first side wall at a first end;
a second end wall rotatably mounted to the first wall at a second end;
a second component configured to releasably attach to the first component;
wherein the first component and the second component surround the tire when the second component is releasably attached to the first component.

18. The device of claim 17, further comprising:
at least one cutout extending through one of the first component and the second component; and
a plurality of sliding panels configured to move between:
a first position where the plurality of sliding panels is located beneath the cutout; and
a second position where the plurality of sliding panels cover at least a portion of the cutout.

19. The device of claim 18, wherein in the second position the plurality of sliding panels abut an axle of the vehicle.

20. The device of claim 17, further comprising:
a first u-channel member comprising a first tab, a second tab, and a first channel formed between the first tab and the second tab;
a second u-channel member comprising a third tab, a fourth tab, and a second channel formed between the third tab and the fourth tab;
wherein the first u-channel member is mounted to a first end of the second component;
wherein the second u-channel member is mounted to a second end of the second component;
wherein the first end wall is releasably secured within the first u-channel member; and
wherein the second end wall is releasably secured within the second u-channel member.
